(19) United States
(12) Patent Application Publication
(10) Pub. No.: US 2008/0237957 A1
(43) Pub. Date: Oct. 2, 2008

(54) ADJUSTABLE STROKE GRIPPER

(76) Inventor: Conrad Earl Waldorf, Pinckney, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/691,610

(22) Filed: Mar. 27, 2007

(51) Int. Cl. B23Q 3/08; B25J 15/02

(52) U.S. Cl. 269/27; 269/285; 269/32

(57) ABSTRACT

A fluid-driven actuator includes a chamber having a first stop and a second stop, a member that is extendable and retractable from the chamber, and a piston that is moveable toward the first stop to extend the member from the chamber and toward the second stop to retract the member into the chamber. The first stop is adjustable to vary a distance between the first stop and the second stop.

### BACKGROUND OF THE INVENTION

This invention generally relates to automated handling equipment. More particularly, this invention relates to an actuated gripper device.

Automated handling equipment is typically employed in industrial settings for transferring work pieces between work stations. Typically, the equipment includes a fluid-actuated gripper that clamps the work pieces while moving them between the stations.

Conventional fluid-actuated grippers include a fluid actuator, such as a pneumatic or hydraulic cylinder, that linearly reciprocates a piston. The piston is coupled to a cam pin that is received through cam slots of two opposed gripper jaws. Each gripper jaw is pivotable about a pivot pin that extends into side walls that extend from the fluid actuator. As the piston reciprocates, the cam pin slides along the cam slots to selectively pivot the jaws about the pivot pins between open and closed jaw positions.

The jaws of typical fluid-actuated grippers are removable and replaceable with different jaws to accommodate work pieces of varying shapes and sizes or to provide different open jaw positions. For example, jaws having different cam slot lengths and shapes (i.e., slot angles) may be substituted. The cam slot length and shape defines the open position of the jaws. Alternatively, adjustable stops on the jaws are used to limit the degree to which the jaws open, for example.

Although conventional grippers are effective for clamping and transferring work pieces or other objects, using replaceable jaws or stops to change the size of the gripper opening adds complexity and is time consuming. Additionally, jaws and stops that are not in use require storage space and may become lost.

Accordingly, there is a need for an actuator and a gripper assembly that provides adjustment of the degree to which the jaws open without having to replace the jaws or use adjustable stops on the jaws. This invention addresses those needs and provides enhanced capabilities while avoiding the shortcomings and drawbacks of the prior art.

### SUMMARY OF THE INVENTION

An example fluid-driven actuator includes a chamber having a first stop and a second stop, a member that is extendable and retractable from the chamber, and a piston that is moveable toward the first stop to extend the member from the chamber and toward the second stop to retract the member into the chamber. The first stop is adjustable to vary a distance between the first stop and the second stop.

An example fluid-driven gripper assembly includes at least one gripper jaw, and a chamber having a proximal stop and a distal stop relative to the at least one gripper jaw for defining a range of movement of a piston within the chamber. The proximal stop is adjustable to vary the range of movement.

An example method of controlling a fluid-driven gripper assembly includes the steps of reciprocally moving the piston within the chamber over a distance between the proximal stop and the distal stop relative to the at least one gripper jaw to reciprocally move the at least one gripper jaw through the range of movement, and adjusting the proximal stop to vary the distance between the proximal stop and the distal stop to thereby vary the range of movement.

### BRIEF DESCRIPTION OF THE DRAWINGS

FIG. 1 illustrates example gripper assemblies in an example industrial setting.

FIG. 2 is a perspective view of an example gripper assembly.

FIG. 3 is an exploded view of the example gripper assembly.

FIG. 4 is a cross-sectional view of a portion of the example gripper assembly.

### DETAILED DESCRIPTION OF THE PREFERRED EMBODIMENT

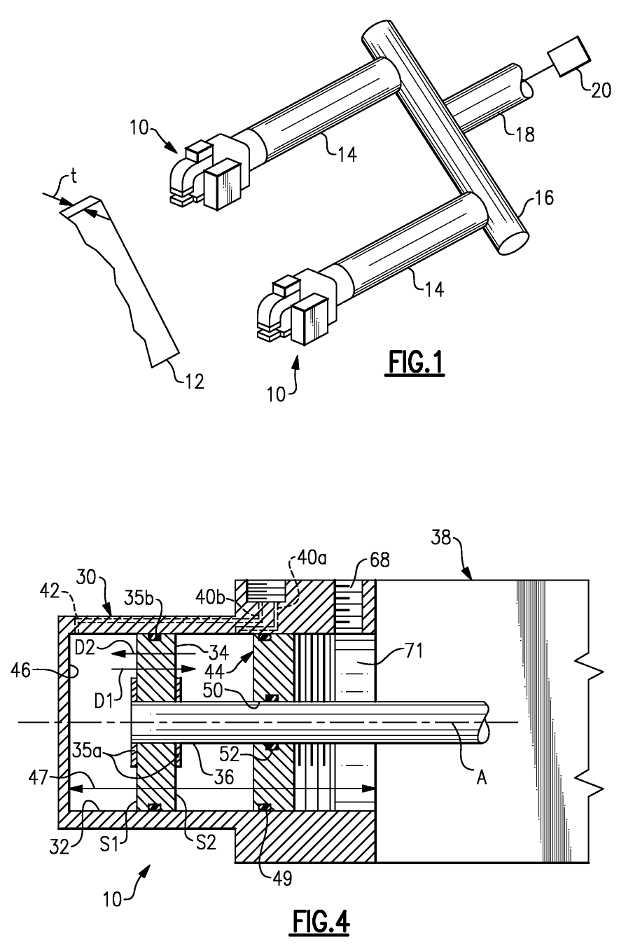

FIG. 1 illustrates selected portions of several gripper assemblies 10 used in an example industrial setting to grip and move a work piece 12 (shown schematically). The gripper assemblies 10 may be used in a variety of different configurations from that shown. In this example, the gripper assemblies 10 are coupled to extended arms 14, which are each secured to a rail 16. An adapter arm 18 is secured to the rail 16. An automated machine 20, such as a robot, moves the adapter arm 18, the extended arms 14, and the gripper assemblies 10 to desired positions to retrieve and deposit the work pieces 12, such as between work stations.

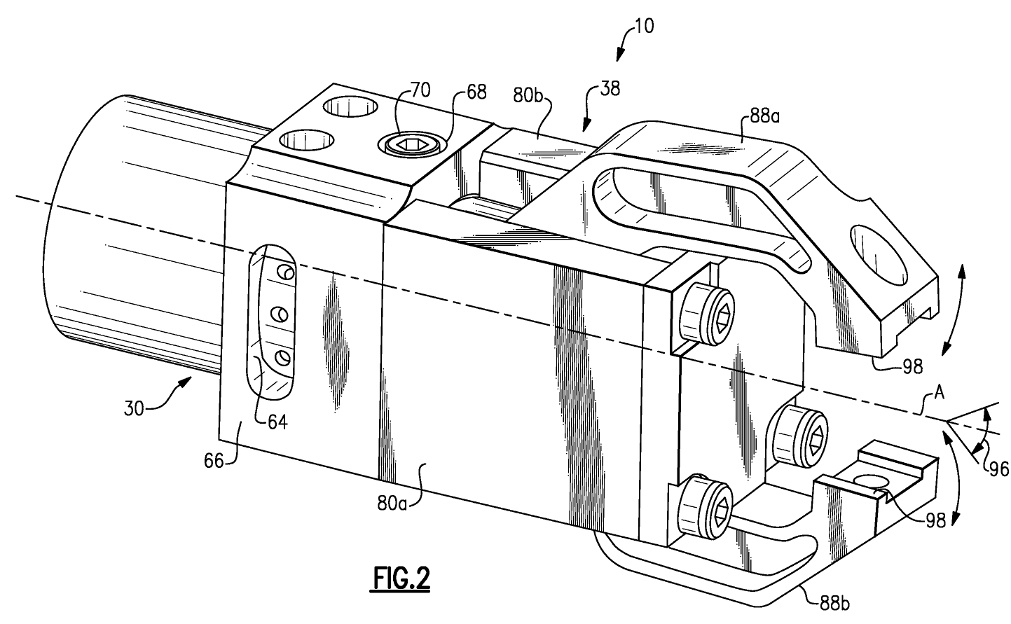

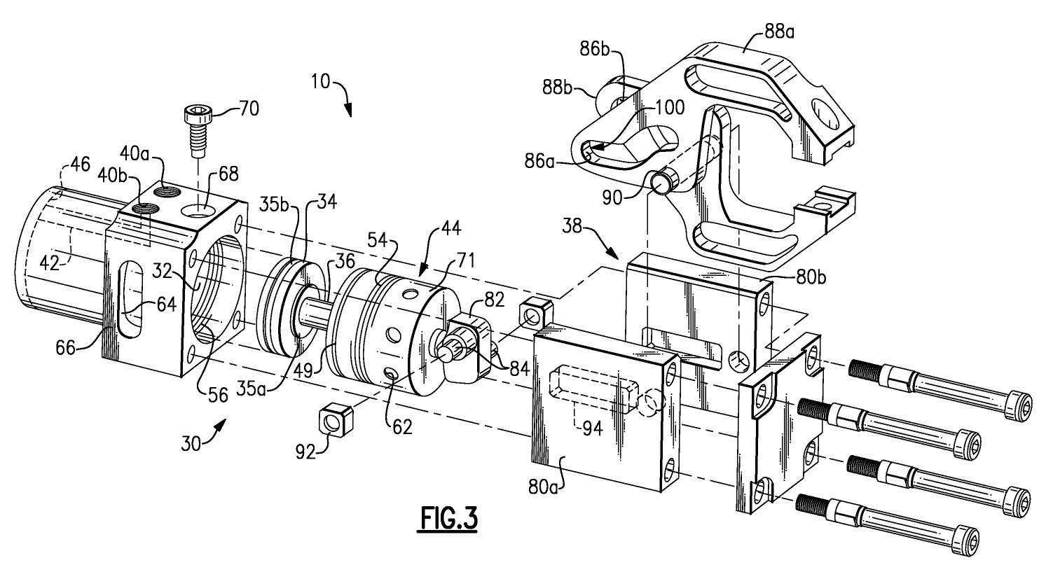

FIG. 2 shows an example of one of the gripper assemblies 10. FIG. 3 illustrates an exploded view of the gripper assembly 10, and FIG. 4 illustrates a cross-section through a portion of the gripper assembly 10. With reference to these figures, the example gripper assembly 10 includes an actuator 30, such as a pneumatic or hydraulic actuator. It is to be understood that other types of actuators may also be used. The actuator 30 includes a cylinder chamber 32 in which a piston 34 reciprocates. The piston 34 optionally includes bumpers 35a, such as a resilient polymer, on each side to cushion impact of the piston 34 as it reciprocates within the cylinder chamber 32. The piston 34 may also include a seal 35b such that the piston 34 separates the cylinder chamber 32 into two sealed sections. The piston 34 is coupled to a piston shaft 36 (i.e., a member) that extends from the actuator 30 into a gripper portion 38 of the gripper assembly 10. Although a shaft is shown, other geometries may alternatively be used. Given this description, one of ordinary skill in the art will recognize the application of the disclosed example actuator 30 to devices other than grippers.

The actuator 30 of the disclosed example includes two fluid ports 40a and 40b that fluidly connect to the respective separated sections of the cylinder chamber 32. In this example, the fluid port 40b includes a fluid passage 42 for providing pressurized fluid to the section of the cylinder chamber 32 behind the piston 34 that exerts a force on a back side S1 of the piston 34 to move the piston 34 and the piston shaft 36 in a forward direction D1. The fluid port 40a provides pressurized fluid to the section of the cylinder chamber 32 in front of the piston 34 that exerts a force on a front side S2 the piston 34 to move the piston 34 and the piston shaft 36 in a retract direction D2.

The actuator 30 also includes a first stop 44 near the front of the cylinder chamber 32 (relative to the gripper portion 38) and a second stop 46 near the back of the cylinder chamber 32 that define a range of travel 47 of the piston 34. That is, the range of travel 47 corresponds to a stroke of the piston shaft 36.

In one example, the second stop 46 is a rear wall of a housing that forms the cylinder chamber 32. Alternatively, the second stop 46 may be a separate piece that is secured into the back of the cylinder chamber 32.

The first stop 44 includes an opening 50, such as a central bore, having a seal 52. The piston shaft 36 extends through the opening 50 of the first stop 44 into the gripper portion 38.

The first stop 44 is adjustable relative to the cylinder chamber 32 and the second stop 46 to change the range of travel 47 and thereby change the stroke of the piston shaft 36. In the illustrated example, the first stop 44 includes a seal 49 for sealing the cylinder chamber 32, and a periphery having threads 54 that intermesh with corresponding threads 56 within the cylinder chamber 32. Rotation of the first stop 44 about axis A axially moves the first stop 44 into or out of the cylinder chamber 32 to thereby change the range of travel 47. The axial length of the threads 54, 56 determines a range of adjustability of the first stop 44. The first stop 44 can thereby provide an infinite number of non-incremental positions between the first stop 44 and the second stop 46. In other words, the first stop 44 is not limited to incremental preset positions and thereby provides a benefit of greater adjustability than known gripper assemblies. In some examples, acme type threading is used to provide ease of manufacturing and thread strength.

In this example, the first stop 44 also includes a manual adjustment portion 60 having sockets 62 spaced circumferentially there about for engaging a tool to rotate the first stop 44. The sockets 62 align with an opening 64 in a side wall 66 of the actuator 30. In one example, a user inserts the tool into one of the sockets 62 to manually rotate the first stop 44 to achieve a desired range of travel 47. Side access of the adjustment portion 60 provides the benefit of convenience for a user to adjust the range of travel 47 because the backs and fronts of grippers are not typically easily accessible in an industrial setting.

Optionally, the side wall 66 of the actuator also includes another opening 68 for receiving a set screw 70 that can be selectively tightened to prevent rotation of the first stop 44 and thereby lock the first stop 44 in a desired position. In the illustrated example, an axial length of a forward surface 71 of the first stop 44 corresponds to the axial length of the threads 54 such that at least a portion of the forward surface 71 aligns with the opening 68 at all axial positions of the first stop 44. The set screw 70 frictionally engages the forward surface 71 of the first stop 44 to resist rotation of the first stop 44.

The piston shaft 36 extends from the actuator 30 into the gripper portion 38. The gripper portion 38 can be any of a variety of different arrangements and is not limited to the illustrated arrangement. In the disclosed example, the gripper portion 38 includes two side walls 80a and 80b. The end of the piston shaft 36 is coupled with a head 82 having a pair of offset cam pins 84. Other configurations may use a single cam pin.

The cam pins 84 extend through respective cam slots 86a and 86b within respective gripper jaws 88a and 88b. Each jaw 88a and 88b is pivotable about a pivot pin 90. Depending on the design of the gripper portion 38, a single pivot pin 90 may be used as shown, or each jaw 88a and 88b may have its own pivot pin. The ends of each cam pin 84 include a bushing 92 that is received into a slot 94 within each the side walls 80a and 80b. The cam slots 86a and 86b have a S-shape such that when the actuator 30 extends or retracts the piston 34 and the piston shaft 36, the jaws 88a and 88b pivot about the pivot pin 90 between a closed position and an open position as the cam pins 84 slide along the cam slots 86a and 86b.

In the disclosed example, movement of the piston 34 and piston shaft 36 in the forward direction D1 opens the jaws 88a and 88b, and movement in the retract direction D2 closes the jaws 88a and 88b. The range of travel 47 of the piston 34, i.e., the piston stroke, corresponds to a degree to which the jaws open, represented generally in FIG. 2 as numeral 96. In this example, the degree of opening 96 is the angle between jaw faces 98 of the jaws 88a and 88b relative to axis A of the piston shaft 36. It is to be understood that the degree 96 of jaw opening can also be expressed relative to other reference axes or to other portions of the jaws 88a and 88b.

The adjustability of the first stop 44 provides the advantage of allowing a user to limit the degree 96 to which the jaws 88a and 88b open to provide a desired clearance around machinery (e.g. dies, presses, etc.) in which the gripper assembly 10 operates. For example, the space within a press may be limited such that adjustment of the degree of opening 96 is needed to avoid interference between the jaws 88a and 88b and the press.

The actuator 30 of the disclosed example gripper assembly 10 also provides a greater jaw opening force than a jaw closing force. That is, the force that the pressurized fluid exerts on the piston 34 in the forward direction D1 is greater than the force in the retract direction D2 because of a difference in the areas of the sides S1 and S2 of the piston 34. The area of side S2 is smaller than the area of side S1 by an amount approximately equal to the area of the piston shaft 36 because the coupling between the piston shaft 36 and the side S2 of the piston 34 reduces the area of the side S2.

The greater amount of opening force provides the benefit of using a peak available force of the actuator 30 to overcome friction in the gripper portion 38, which is greatest when moving the jaws 88a and 88b from closed to open (i.e., moving the piston 34 in the forward direction D1). For example, there may be friction between the cam pins 84 and the cam slots 86a and 86b and friction between the bushings 92 and the slots 94 that must be overcome before the jaws 88a and 88b are able to open. In the disclosed example, the friction between the cam pins 84 and the cam slots 86a and 86b is greatest near the back ends 100 of the S-shaped cam slots 86a and 86b.

The disclosed example gripper assembly 10 therefore provides the advantage of permitting control over the degree to which the jaws 88a and 88b open without having to substitute different jaws and without using stops on the jaws 88a and 88b. In some examples, this eliminates the need for replacement jaws, which require storage space and are vulnerable to misplacement.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A fluid-driven actuator comprising:
a chamber having a first stop and a second stop;
a member that is extendable and retractable from the chamber; and
a piston that is moveable toward the first stop to extend the member from the chamber and toward the second stop to retract the member into the chamber, where the first stop is adjustable to vary a distance between the first stop and the second stop.

2. The fluid-driven actuator as recited in claim 1, wherein the first stop includes an opening, and the member extends through the opening.

3. The fluid-driven actuator as recited in claim 1, wherein the member is a rod coupled with the piston and extending from the chamber.

4. The fluid-driven actuator as recited in claim 1, wherein the first stop includes an outer periphery having threads.

5. The fluid-driven actuator as recited in claim 1, wherein the first stop includes threads and the chamber comprises a bore having a threaded portion for engaging the threads of the first stop.

6. The fluid-driven actuator as recited in claim 1, wherein the first stop is rotatable relative to the chamber.

7. The fluid-driven actuator as recited in claim 1, further comprising a bumper between the piston and at least one of the first stop or the second stop.

8. The fluid-driven actuator as recited in claim 1, further comprising a pair of gripper jaws coupled with the member.

9. The fluid-driven actuator as recited in claim 1, wherein the first stop comprises a front of the chamber and the second stop comprises a back of the chamber, where the chamber further comprises at least one side wall between the front and the back, and the side wall includes an opening that extends through the side wall to the first stop.

10. The fluid-driven actuator as recited in claim 1, wherein the first stop comprises a plurality of sockets spaced around a circumference of the first stop for rotating the first stop.

11. A fluid-driven gripper assembly comprising:
at least one gripper jaw; and
a chamber having a proximal stop and a distal stop relative to the at least one gripper jaw for defining a range of movement of a piston within the chamber, where the proximal stop is adjustable to vary the range of movement.

12. The fluid-driven actuator as recited in claim 11, wherein the chamber is cylindrical and includes a back end and a front end between the back end and the at least one gripper jaw, where the proximal stop is located at the front end and the distal stop is located at the back end.

13. A method of controlling a fluid-driven gripper assembly, comprising:
(a) reciprocally moving a piston within a chamber over a distance between a proximal stop and a distal stop relative to at least one gripper jaw to reciprocally move the at least one gripper jaw through a range of movement; and
(b) adjusting the proximal stop to vary the distance between the proximal stop and the distal stop to thereby vary the range of movement.

14. The method as recited in claim 13, wherein said step (b) includes rotating the proximal stop to vary the distance.

15. The method as recited in claim 13, wherein said step (a) includes cushioning an impact between the piston and at least one of the proximal stop or the distal stop with a bumper.

16. The method as recited in claim 13, wherein said step (a) includes moving the piston toward the proximal stop to extend a member from the chamber.

17. The method as recited in claim 13, wherein the at least one gripper jaw includes a pair of gripper jaws and said step (a) includes moving the piston toward the proximal stop to open the pair of gripper jaws.
